(19) United States
(12) Patent Application Publication
(10) Pub. No.: US 2014/0349218 A1
(43) Pub. Date: Nov. 27, 2014

(54) PHOTOSENSITIVE MATERIAL, HOLOGRAPHIC RECORDING MEDIUM AND HOLOGRAPHIC RECORDING METHOD

(71) Applicant: NIPPON STEEL & SUMIKIN CHEMICAL CO., LTD, Tokyo (JP)

(72) Inventors: Takehiro Shimizu, Kitakyushu-shi (JP); Toshio Ando, Kitakyushu-shi (JP); Kazuyoshi Masaki, Kitakyushu-shi (JP)

(73) Assignee: NIPPON STEEL & SUMIKIN CHEMICAL CO., LTD, Tokyo (JP)

(21) Appl. No.: 14/358,168

(22) PCT Filed: Nov. 12, 2012
(86) PCT No.: PCT/JP2012/007242

§ 371 Date: May 14, 2014

(30) Foreign Application Priority Data
Nov. 14, 2011 (JP) 2011-248249

(51) Int. Cl. G03H 1/02; G03H 1/22

(52) U.S. Cl. CPC G03H 1/02; G03H 1/22; G03H 2001/0264
USPC 430/2

(57) ABSTRACT

A photosensitive material includes: a polymer matrix, a radical polymerization monomer and photo-radical polymerization initiator, wherein the polymer matrix has stable nitroxy radical at side chain thereof, wherein a molar ratio of the stable nitroxy radical to the radical polymerization monomer is set within a range of 0.03 to 0.25.

### TECHNICAL FIELD

The present invention relates to a photosensitive material which is preferably employed for a holographic recording medium not requiring scheduling technique, a holographic recording medium and a holographic recording method.

### BACKGROUND OF THE RELATED ART

Holographic recording is conducted as the interference fringes which are made by the simultaneous irradiation of signal optical beam having signal information and reference optical beam is recorded as a diffraction grating (hereinafter, often called as “grating”) in a recording medium. Holographic reproducing is conducted as reference optical beam is irradiated onto the recording medium in which the image information is recorded to read the image information out as reproducing signal beam.

As the recording material, photopolymer is often employed in view of the simplification and convenience in the manufacture of the recording medium and the variation of material selection. In the holographic recording medium using the photopolymer, a write-once type recording medium is normal in which the interference pattern is recorded as refractive index modulation diffraction grating.

According to the holographic recording, the image information is once recorded and reproduced as one page per page unit and recorded in the same area of the recording medium in a state of superimposition (hereinafter, called as “multiple recording”, so that the holographic recording is expected as photo-recording technique having high transfer rate and large capacity which can be substituted for bit-by-bit data storage technique which is employed for conventional CDs, DVDs and Blue-ray discs.

In holographic recording medium, large M# (m number) is required in order to realize the large capacity. The M# is an index representing multiple recording performance and, when the diffraction efficiency of i-th page is defined as ηi, designated by the following equation:

$$M \# = {\sum }_{i = 1}^{m} \sqrt{{η}_{i}}$$

In the holographic recording medium, moreover, high recording sensitivity is required in order to realize the sufficient diffraction efficiency during short period of time for high transfer rate.

In the case that the multiple recording is conducted using the write-once type holographic recording medium, normally, some recordable components (here, means radical polymerization monomer; the same shall apply hereinafter) are changed through photoreaction at first page recording, the remnant recordable unreacted components are changed through photoreaction at second page recording, the further remnant recordable unreacted components are changed through photoreaction at the third page recording, and the still further remnant recordable unreacted components . . . are changed through photoreaction at the n-th page recording.

The remnant recordable components are decreased as the multiple recording is repeated, and then the recording sensitivity is deteriorated. Namely, if each page is recorded by the same exposure energy, the intensity of the reproducing signal is decreased in the latter multiple recorded page, causing disadvantage in recording/reproducing system.

In order to iron out the aforementioned disadvantage, scheduling technique is employed, which is intended to uniformize the intensity of the reproducing signal from each page by predicting the change in intensity of the reproducing signal through multiple recording, that is, the change of the recording sensitivity so that the multiple recording is conducted while the exposure energy is changed per page.

In the scheduling technique, the recording processes for pages of which the sensitivities are predicted to be lowered are conducted using respective recording optical beams having the corresponding higher exposure energies. In order to change the exposure energy which is represented by the multiplication of exposure power and exposure period of time, it is required that at least one of the exposure energy and the exposure period of time is changed. In order to change the exposure power per page, however, the complicated control in the corresponding recording system is required, so that the exposure energy is normally changed by adjusting the exposure period of time. Namely, it is required that the exposure period of time is elongated in order to conduct the high exposure energy recording, causing the deterioration of transfer rate in the recording system.

Such a recording medium as the intensity of the reproducing signal per page can be uniformized without scheduling technique is desired in order to realize the large capacity and the high transfer rate thereof in the corresponding simple recording/reproducing system.

Patent document No. 1 discloses the holographic recording medium which has a recording layer made from radical polymerization monomer, photo-radical polymerization initiator, polymer matrix and polymerization inhibitor which is selected from the group consisting of phenol derivative, hindered amine and nitroxide compound and coupled with the polymer matrix through covalent bond.

However, since the holographic recording medium disclosed in Patent document No. 1 has the polymerization inhibitor, preliminary exposure (hereinafter, often called as “exposure before recording”) is conducted prior to the recording so as to deactivate the polymerization inhibitor. According to the technique disclosed in Patent document No. 1, the aforementioned preliminary exposure can be conducted under a predetermined condition. Even in the technique disclosed in Patent document No. 1, however, the scheduling is still required.
Patent document No. 1: Japanese Patent Application Laid-open No. 2010-66326

### DISCLOSURE OF THE INVENTION

### Problem to be Solved by the Invention

It is an object of the present invention to provide a photosensitive material which can realize high M#, high sensitivity and require no scheduling and preliminary exposure when used as a holographic recording material, a holographic recording medium made from the photosensitive material which can realize a large capacity (high density) and high transfer rate, and a holographic recording method.

### Technical Solution

In order to achieve the object of the present invention, the present invention relates to a photosensitive material, including: a polymer matrix, a radical polymerization monomer and photo-radical polymerization initiator, wherein the polymer matrix has stable nitroxy radical at side chain thereof, wherein a molar ratio of the stable nitroxy radical to the radical polymerization monomer is set within a range of 0.03 to 0.25.

The present invention also relates to a holographic recording medium, including: at least one transparent substrate; and an information recording layer made of the photosensitive material and formed on the transparent substrate.

Moreover, the present invention relates to a holographic recording method, including a step of: forming a plurality of refractive index modulation diffraction gratings which are superimposed in the holographic recording medium by the same exposure energy.

Furthermore, the present invention relates to a holographic recording method, including a step of: forming at least one refractive index modulation diffraction grating in the holographic recording medium.

The photosensitive material constituting the information recording layer of the holographic recording medium according to the present invention has stable nitroxy radicals at the side chains of the polymer matrix thereof. Therefore, the stable nitroxy radicals fixed at the polymer matrix are spatially dispersed and arranged at an appropriate ratio so that excess polymerization at the initial stage of the multiple recording can be suppressed and excess polymerization at the whole stage of the multiple recording can be suppressed. Moreover, the refractive index modulation structure, which is surely reflected from the light intensity distribution of the interference fringes, can be formed and the recordable components (radical polymerization monomer) can be utilized without waste. It is considered that the recording sensitivity can be developed on the aforementioned interdependent advantages so as to realize high M#. As a result, the intended holographic recording medium having large capacity (high density) and high transfer rate can be obtained without scheduling and preliminary exposure.

In an aspect of the present invention, the polymer matrix has a compound with aromatic ring and radical polymerization reactive group as component unit. In this case, since the polymer matrix has the aromatic ring, the radical polymerization monomer of high refractive index having aromatic ring in the photosensitive material has high compatibility for the polymer matrix and difficulty in muddiness, so that a relatively large amount of radical polymerization monomer can be contained in the photosensitive material. In this manner, the refractive index modulation degree of the photosensitive material can be developed.

Moreover, since in the exposure of the photosensitive material, at least a portion of the radical polymerization monomer is reacted with the radical polymerization reactive group so as to generate the covalent bond for the polymer matrix, the compatibility, that is, the transparence of the photosensitive polymer can be developed and the refractive index modulation structure, which is already formed in the photosensitive material, can be stabilized.

In the case that the photosensitive material is used as the information recording layer of the holographic recording medium, therefore, since a plurality of diffraction gratings can be formed under high contrast by the refractive index modulation structure, a plurality of page information corresponding the respective diffraction gratings can be recorded and reproduced under high SNR.

### Effect of the Invention

According to the present invention can be provided a photosensitive material which can realize high M#, high sensitivity and require no scheduling and preliminary exposure when used as a holographic recording material, a holographic recording medium made from the photosensitive material which can realize a large capacity (high density) and high transfer rate, and a holographic recording method.

### BRIEF DESCRIPTION OF THE DRAWINGS

FIG. 1 is a structural view schematically showing an optical system for multiple recording which is used in SNR evaluation in Examples.

FIG. 2 is a structural view schematically showing an optical system for reproducing in the SNR evaluation in Examples.

FIG. 3 is a view showing a recording signal light pattern which is used in the SNR evaluation in Examples.

FIG. 4 is a graph showing the integrated value of the M# for the recording exposure energy in Examples.

FIG. 5 is a graph showing the sensitivity for the recording exposure energy in Examples.

FIG. 6 is a graph showing an SNR per page when 540 multiple recording is conducted in Examples.

FIG. 7 is a graph showing an SNR per page when 540 multiple recording is conducted in Examples.

FIG. 8 is a graph showing a recording exposure energy per page in Examples.

FIG. 9 is a graph showing an SNR per page when 135 multiple recording is conducted in Examples.

### MODE FOR CARRYING OUT THE INVENTION

Hereinafter, embodiments of the present invention will be described with reference to drawings.

(Polymer Matrix)

As the polymer matrix composing the photosensitive material of the present invention can be exemplified isocyanate-hydroxy polyaddition compound, isocyanate-amine polyaddition compound, isocyanate-thiol polyaddition compound, epoxy-amine polyaddition compound, epoxy-thiol polyaddition compound, episulphide-amine polyaddition compound and episulphide-thiol polyaddition compound. Particularly, in view of the reaction under relatively soft temperature condition, optical property and little bad odor, isocyanate-hydroxy polyaddition compound is preferable.

As the polyisocyanate component composing the isocyanate-hydroxy polyaddition compound is used isocyanate compound having two or more isocyanate groups in one molecule or a mixture thereof. Tolylene diisocyanate (TDI), diphenylmethane-4,4′-diisocyanate (MDI), xylylene diisocyanate (XDI), tetramethyl xylylenediisocyanate (TMXDI), naphthylene-1,5′-diisocyanate (NDI), triphenylmethane-4,4′,4″-triisocyanate, dicychlohexylmethane-4,4′-diisocyanate (H12MDI), hydrogenation xylylene diisocyanate (H6XDI), hexamethylene diisocyanate (HDI), trimethyl hexamethylene diisocyanate (TMHDI), isophorone diisocyanate (IPDI), norbornane diisocyanate (NBDI), cychlohexane-1,3,5-triisocyanate, trimer, biuret product, adduct product and prepolymer of isocynate compound can be exemplified. These isocyanate compounds can be used single or in combination of two kinds or more thereof.

As the polyol component composing the isocyanate-hydroxy polyaddition compound is used hydroxyl compound having two or more hydroxyl groups in one molecule or a mixture thereof. Polyetherpolyols, polyestherpolyols or polycarbonate diols can be exemplified. These hydroxyl compounds may be used single or in combination of two of more kinds thereof.

(Radical Polymerization Monomer)

The photosensitive material of the present invention can be preferably employed for the recording material of the holographic recording medium. In the holographic recording medium, the polymer matrix of low refractive index and the radical polymerization monomer of high refractive index are contained so that in recording the radical polymerization monomer is polymerized so as to form the refractive index modulation structure in the holographic recording medium and thus form the plurality of diffraction gratings under high contrast. In this manner, the plurality of page information corresponding to the respective diffraction gratings can be recorded and reproduced under high SNR.

The radical polymerization monomer composing the photosensitive material of the present invention are not limited only if known by the person skilled in the art, but preferably is a radical polymerization monomer of high refractive index having aromatic ring in molecule thereof.

As the radical polymerization monomer of high refractive index having aromatic ring in molecule thereof styrene, chlorostyrene, bromostyrene, α-methylstyrene, divinylbenzene, vinylnaphthalene, divinylnaphthalene, vinylbiphenyl, divinylbiphenyl, vinylterphenyl, vinylpyrene, indene, acenaphthylene, dibenzofulvene, phenyl(vinylphenyl)sulfide, benzyl(vinylbenzyl)sulfide, N-vinylcarbazole, phenyl(meta)acrylate, benzyl(meta)acrylate, phenoxyethyl(meta)acrylate, naphthoxyethyl(meta)acrylate, tribromophenyl(meta)acrylate, tribromophenoxyethyl(meta)acrylate, alkylene oxide modified bisphenol A-di(meta)acrylate, 9,9-bis(4-hydroxyphenyl)fluorine-di(meta)acrylate, 9,9-bis(4-hydroxy-3-methylphenyl)fluorine-di(meta)acrylate, 9,9-bis(4-(2-hydroxyethoxy)phenyl)fluorine-di(meta)acrylate, bis(4-metacryloylthiophenyl)sulfide and bis(4-vinylthiophenyl)sulfide. These radical polymerization monomers can be used single or in combination of two or more kinds thereof.

The content of the radical polymerization monomer is preferably set within a range of 0.5 to 30 mass % for the whole content of the photosensitive material, preferably within a range of 1 to 20 mass % therefor and more particularly within a range of 1.5 to 10 mass %.

Here, the wording “monomer” encompasses “oligomer” exhibiting polymerization.

(Photo-Radical Polymerization Initiator)

The photo-radical polymerization initiator composing the photosensitive material of the present invention functions as starting the polymerization of the radical polymerization monomer in recording, can be made of the one known by the person skilled in the art and can be appropriately selected in view of the wavelength of light to be used.

As the preferable photo-radical polymerization initiator can exemplified bis(η⁵-2,4-cyclopenthadiene-1-yl)bis(2,6-difluoro-3-(1H-pyrol-1-yl)phenyl)titanium,bis(2,4,6-trimethylbenzoyl)phenylphosphine oxide, 2,4,6-trimethylbenzoyl diphenylphosphine oxide, 2-benzyl-2-(dimethylamino)-1-[4-(morpholine-4-yl)phenyl]buthane-1-one, 2-(dimethylamino)-2-(4-methylbenzyl)-1-[4-(morpholine-4-yl)phenyl]buthane-1-one, 2-methyl-1-[4-(methylthio)phenyl]-2-(morpholine)-4-yl)propane-1-one and (1-hydroxycyclohexyl)phenyl ketone.

The content of the photo-radical polymerization initiator cannot be flatly determined because it depends on the kind thereof and the content of the radical polymerization monomer, but preferably set within a range of 0.05 to 10 mass % for the whole content of the photosensitive material, more preferably within a range of 0.1 to 5 mass % therefor and particularly preferably within a range of 0.15 to 3 mass % therefor.

(Stable Nitroxy Radical)

Since the photosensitive material of the present invention of the present invention has stable nitroxy radials at the side chains of the polymer matrix, the recording sensitivity of the photosensitive material can be increased so as to realize high M#. As a result, the intended holographic recording medium having large capacity (high density) and high transfer rate can be obtained without scheduling and preliminary exposure.

It is considered that the stable nitroxy radicals fixed at the polymer matrix are spatially dispersed and arranged at an appropriate ratio so that excess polymerization at the initial stage of the multiple recording can be suppressed and excess polymerization at the whole stage of the multiple recording can be suppressed, and the refractive index modulation structure, which is surely reflected from the light intensity distribution of the interference fringes, can be formed and the recordable components (radical polymerization monomer) can be utilized without waste.

The stable nitroxy radical is made of one commercially available, but preferably made of the following chemical formula:

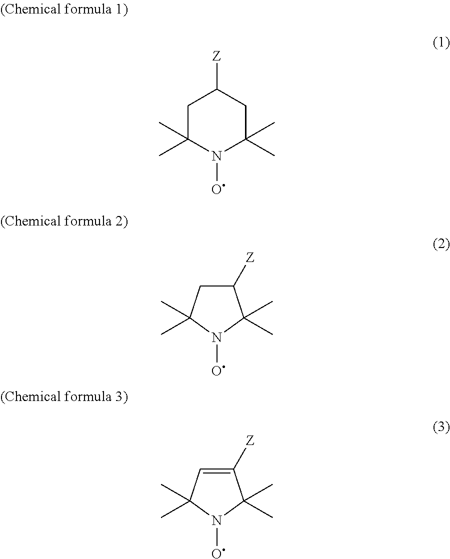

(Z represents hydroxyl group, amino group, carboxyl group, carbamoyl group or glycidyl group)

Since these stable nitroxy radicals has hydroxyl group, amino group, carboxyl group, carbamoyl group or glycidyl group, these stable nitroxy radicals can be coupled with the groups at the side chains of the polyadditive compound composing the polymer matrix through addition reaction.

As the stable nitroxy radical represented by the chemical formula 1 can be exemplified 4-hydroxy-2,2,6,6-tetramethylpiperidine-1-oxyl, 4-sulfanyl-2,2,6,6-tetramethylpiperidine-1-oxyl, 4-amino-2,2,6,6-tetramethylpiperidine-1-oxyl, 4-carboxy-2,2,6,6-tetramethylpiperidine-1-oxyl, 4-carbomoyl-2,2,6,6-tetramethylpiperidine-1-oxyl and 4-(2,3-epoxypropoxy)-2,2,6,6-tetramethylpiperidine-1-oxyl.

As the stable nitroxy radical represented by the chemical formula 2 can be exemplified 3-hydroxy-2,2,5,5-tetramethylpyrrolidine-1-oxyl, 3-sulfanyl-2,2,5,5-tetramethylpyrrolidine-1-oxyl, 3-amino-2,2,5,5-tetramethylpyrrolidine-1-oxyl, 3-carboxy-2,2,5,5-tetramethylpyrrolidine-1-oxyl, 3-carbomoyl-2,2,5,5-tetramethylpyrrolidine-1-oxyl and 3-(2,3-epoxypropoxy)-2,2,5,5-tetramethylpyrrolidine-1-oxyl.

As the stable nitroxy radical represented by the chemical formula 3 can be exemplified 3-hydroxy-2,2,5,5-tetramethylpyrroline-1-oxyl, 3-sulfanyl-2,2,5,5-tetramethylpyrroline-1-oxyl, 3-amino-2,2,5,5-tetramethylpyrroline-1-oxyl, 3-carboxy-2,2,5,5-tetramethylpyrroline-1-oxyl, 3-carbomoyl-2,2,5,5-tetramethylpyrroline-1-oxyl and 3-(2,3-epoxypropoxy)-2,2,5,5-tetramethylpyrroline-1-oxyl.

The content of the stable nitroxy radial is preferably set within a range of 0.03 to 0.25 molar ratio for the radical polymerization monomer, more preferably within a range of 0.04 to 0.23 molar ratio therefor and particularly preferably within a range of 0.05 to 0.2 molar ratio therefor. If the content of the stable nitroxy radical is set too much, the intended radical polymerization reaction cannot be sufficiently proceeded at recording exposure and the intended refractive index modulation degree required for the formation of the corresponding diffraction grating cannot be obtained, resulting in the deterioration in recording sensitivity of the holographic recording medium. In the other hand, if the content of the stable nitroxy radical is set too little, the aforementioned function/effect of the present invention may not be exhibited.

(Compound Having Radical Polymerization Group)

The polymer matrix of the photosensitive material of the present invention may contain a compound having aromatic ring represented by a prescribed chemical formula and radial polymerization group as component unit.

Such a radical polymerization group can be represented by as following chemical formula 4, 5 or 6:

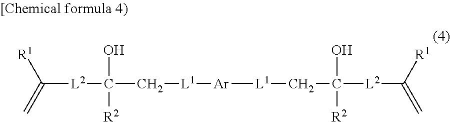

(Ar represents bivalent group having one or more aromatic rings; R¹, R² represent hydrogen atom or methyl group independently; L¹ represents oxygen atom, sulfur atom, —(OR³)nO— (R³ represents alkylene group having 1 to 4 carbon; n=integral number within a range of 1 to 4); L² represents bivalent group capable of having aromatic ring)

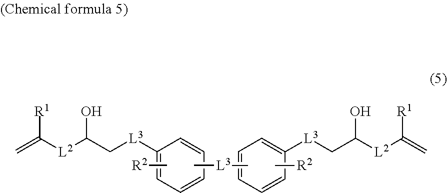

(R¹ represents hydrogen atom or methyl group; R² represents hydrogen atom or alkyl group having 1 to 4 carbon; L¹ represents oxygen atom, sulfur atom, —(OR³)nO— (R³ represents alkylene group having 1 to 4 carbon; n=integral number within a range of 1 to 4); L² represents bivalent group capable of having aromatic ring; L³ represents single bond, oxygen atom, sulfur atom, sulfonyl atom, alkylene group having 1 to 4 carbon or 9,9-fluorenyl group)

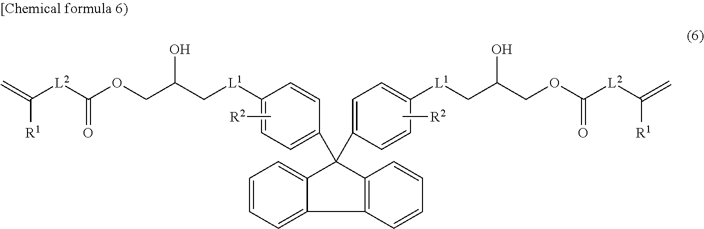

(R¹ represents hydrogen atom or methyl group; R² represents hydrogen atom or alkyl group having 1 to 4 carbon; L¹ represents oxygen atom, sulfur atom, —(OR³)nO— (R³ represents alkylene group having 1 to 4 carbon; n=integral number within a range of 1 to 4); L² represents bivalent group capable of having aromatic ring; L⁴ represents single bond or methylene group)

In this case, since the polymer matrix has the aromatic ring, the radical polymerization monomer of high refractive index having aromatic ring in the photosensitive material has high compatibility for the polymer matrix and difficulty in muddiness, so that a relatively large amount of radical polymerization monomer can be contained in the photosensitive material. In this manner, the refractive index modulation degree of the photosensitive material can be developed.

Moreover, since in the exposure of the photosensitive material, at least a portion of the radical polymerization monomer is reacted with the radical polymerization reactive group so as to generate the covalent bond for the polymer matrix, the compatibility, that is, the transparence of the photosensitive polymer can be developed and the refractive index modulation structure, which is already formed in the photosensitive material, can be stabilized.

In the case that the photosensitive material is used as the information recording layer of the holographic recording medium, therefore, a plurality of diffraction gratings can be formed under high contrast by the refractive index modulation structure, a plurality of page information corresponding the respective diffraction gratings can be recorded and reproduced under high SNR.

The content of the compound having the radical polymerization reactive group represented by chemical formula 4, 5 or 6 is preferably set within a range of 0.5 to 20 mass % for the content of the polymer matrix, more preferably within a range of 1 to 10 mass % therefor and particularly preferably within a range of 1.5 to 6 mass % therefor. If the content of the compound having the radical polymerization reactive group represented by chemical formula 4, 5, or 6 set to much, the viscosity of the photosensitive material becomes higher to complicate the manufacture of the photosensitive material and to deteriorate the function/effect of the present invention relating to the stable nitroxy radical. On the other hand, if the content of the compound having the radical polymerization reactive group represented by chemical formula 4, 5 or 6 is set to zero or too little, the compatibility between the polymer matrix and the radical polymerization monomer and the other polymers may be deteriorated to cause the muddiness in the photosensitive material.

As the compound having the radical polymerization reactive group represented by chemical formula 4 or 5 can be exemplified (meta) acrylic acid additive of bisphenol A type epoxy resin, 3-butenoic acid additive of bisphenol A type epoxy resin, vinylbenzoic acid additive of bisphenol A type epoxy resin, vinylphenol additive of bisphenol A type epoxy resin, vinylthiophenol additive of bisphenol A type epoxy resin, vinylaniline additive of bisphenol A type epoxy resin, (meta)acrylic acid additive of bisphenol F type epoxy resin, 3-butenoic acid additive of bisphenol F type epoxy resin, vinylbenzoic acid additive of bisphenol F type epoxy resin, vinylphenol additive of bisphenol F type epoxy resin, vinylthiophenol additive of bisphenol F type epoxy resin, vinylaniline additive of bisphenol F type epoxy resin, (meta)acrylic acid additive of 9,9-bis(4-(2-hydroxyethoxy)phenyl)fluorene diglycigyl ether, 3-butenoic acid additive of 9,9-bis(4-(2-hydroxyethoxy)phenyl)fluorene diglycigyl ether, vinylbenzoic acid additive of 9,9-bis(4-(2-hydroxyethoxy)phenyl)fluorene diglycigyl ether, vinylphenol additive of 9,9-bis(4-(2-hydroxyethoxy)phenyl)fluorene diglycigyl ether, vinylthiophenol additive of 9,9-bis(4-(2-hydroxyethoxy)phenyl)fluorene diglycigyl ether and vinylaniline additive of 9,9-bis(4-(2-hydroxyethoxy)phenyl)fluorene diglycigyl ether.

As the compound having the radical polymerization reactive group represented by chemical formula 6 can be exemplified(meta)acrylic acid additive of 9,9-bis(4-(2-hydroxyethoxy)phenyl)fluorene diglycigyl ether, 3-butenoic acid additive of 9,9-bis(4-(2-hydroxyethoxy)phenyl)fluorene diglycigyl ether, vinylbenzoic acid additive of 9,9-bis(4-(2-hydroxyethoxy)phenyl)fluorene diglycigyl ether, vinylphenol additive of 9,9-bis(4-(2-hydroxyethoxy)phenyl)fluorene diglycigyl ether, vinylthiophenol additive of 9,9-bis(4-(2-hydroxyethoxy)phenyl)fluorene diglycigyl ether and vinylaniline additive of 9,9-bis(4-(2-hydroxyethoxy)phenyl)fluorene diglycigyl ether from among the aforementioned compounds relating to chemical formula 4 or 5.

The main component of acrylic acid additive of 9,9-bis(4-(2-hydroxyethoxy)phenyl)fluorene diglycigyl ether is the compound under the condition that in chemical formula 6, R¹ is hydrogen atom, R² is hydrogen atom, L¹ is oxygen atom and L² is single bond.

The main component of acrylic acid additive of 9,9-bis(4-(2-hydroxyethoxy)phenyl)fluorene diglycigyl ether is the compound under the condition that in chemical formula 6, R¹ is hydrogen atom, R² is hydrogen atom, L¹ is oxygen atom and L² is single bond.

The main component of 3-butenoic acid additive of 9,9-bis(4-(2-hydroxyethoxy)phenyl)fluorene diglycigyl ether is the compound under the condition that in chemical formula 6, R¹ is hydrogen atom, R² is hydrogen atom, L¹ is oxygen atom and L² is methylene group.

(Others)

The photosensitive material of the present invention and the corresponding photosensitive precursor may contain an additive such as plasticizer, compatibilizer, chain-transfer agent, polymerization promotor, polymerization inhibitor, surfactant, silane coupling agent, antifoaming agent, parting agent, stabilizer, antioxidant and frame retardant as needed.

(Manufacture of Photosensitive Material)

The manufacturing method of the photosensitive material of the present invention will be described. First of all, the formation components of the polymer matrix, e.g., polyisocyanate component, polyol component, which compose isocyanate-hydroxy polymerization additive, photo-radical polymerization reactive group, stable nitroxy radical and as needed compound having radical polymerization reactive group as represented by chemical formula 4 or the like are blended. Then, polymerization reaction except radical polymerization reaction is conducted for the polymer matrix formation components to form the polymer matrix. In this case, the polymer matrix is formed as the polymer matrix formation components are polymerized under the coexistence of the radical polymerization monomer and photo-radical polymerization initiator.

In this manner, the photosensitive material configured such that the radical polymerization monomer and the photo-radical polymerization initiator are contained in the polymer matrix.

On the other hand, if the contents of the radical polymerization monomer and the photo-radical polymerization initiator are decreased through reaction, the properties of the photosensitive material are deteriorated, so that it is desired that the polymer matrix is formed under the condition that the contents of the radical polymerization monomer and the photo-radical polymerization initiator are not decreased. Therefore, catalyst is blended or reaction temperature is controlled such that another polymerization except radical polymerization is preferentially caused.

As the catalyst for isocyanate-hydroxy polyaddition reaction can be exemplified tin compound such as dimethyltin dilaurate and dibutyltin dilaurate and tertialy amine compound such as 1,4-diazabicyclo[2,2,2]octane (DABCO), imidazole derivative, 2,4,6-tris(dimethylaminomethyl)phenol, N,N-dimethylbenzyl amine. These catalysts may be used single or in combination of two or more kinds thereof.

(Holographic Recording Medium)

The holographic recording medium of the present invention has the information recording layer made of the aforementioned photosensitive material.

The holographic recording medium of the present invention may have a top substrate, a bottom substrate, a reflective film and the like as needed.

The holographic recording medium of the present invention may be configured as a transparent holographic recording medium or a reflective holographic recording medium.

Hereinafter, the substrate and the information recording layer included in the holographic recording will be described in detail.

As the substrate material can be normally exemplified glass, ceramics, resin. In view of moldability and cost, the resin is preferable. As the resin can be exemplified polycarbonate resin, acrylic resin, polycycloorefin resin, epoxy resin, polystyrene resin, acrylonitrile-styrene copolymer, ABS resin, polyethylene resin, polypropylene resin, silicone resin, fluororesin, and urethane resin. In view of moldability, optical property and cost, polycarbonate resin, acrylic resin, and polycycloorefin resin are more preferable. Moreover, the substrate surface may be treated by hard-coat or antireflection. Furthermore, a reflective layer may be provided in advance dependent of recording/reproducing method.

The information recording layer is made from the aforementioned photosensitive material, and recorded using holographic recording technique. The thickness of the information recording layer is not limited and appropriately set on the intended us. If the thickness of the information recording layer is set within a range of 1 to 3000 the information recording layer has high transmittance within a wavelength range of 350 to 800 nm advantageously. If the aforementioned substrate is not used, the surface of the information recording layer may be appropriately treated by UV hard resin or antireflection.

The photosensitive material and the recording medium made from the photosensitive material are preferably employed for holographic recording/reproducing, but any holographic recording/reproducing method may be employed. For example, holographic recording/reproducing method on two-beam interference method and coaxial holographic recording/reproducing method where reference beam and information beam are arranged coaxially and focused are employed. In these holographic recording/reproducing, a plurality of refractive index modulation diffraction gratings which are to be superimposed are preferably formed by the substantial same exposure energy. As the treating method for the recording medium, moreover, at least one refractive index modulation diffraction grating is formed without preliminary exposure.

In the case that the plurality of refractive index modulation diffraction gratings which are to be superimposed are formed by the substantial same exposure energy, as the property of the photosensitive material, it is desired that the ratio (Smin/Smax) is set to 0.5 or more and preferably 0.7 or more when the maximum sensitivity in the multiple recording by the same exposure energy is defined as Smax and the minimum sensitivity in the multiple recording by the same exposure energy.

### EXAMPLES

Hereinafter, the present invention will be described in detail accompanied by examples, but not limited to examples.

### Example 1

### Blend of Photosensitive Material

First of all, 33.8 parts by mass of hexamethylene diisocyanate (made by TOKYO CHEMICAL INDUSTRY CO., LTD) and 56.3 parts by mass polyethertriol (made by ADEKA CORPORATION, G-400, mean molecular weight: 425, refractive index nD=1.469) as the polymer matrix formation components, and 0.08 part by mass of dibutyltin dilaurate (made by TOKYO CHEMICAL INDUSTRY CO., LTD) as the polymer matrix formation catalyst) were mixed, and then 0.2 part by mass (0.056 molar ratio for the corresponding polymerization monomer) of 4-hydroxy-2,2,6,6-tetramethylpipelidine-1-oxyl (made by Sigma-Aldrich Co., LLC) as the stable nitroxyl radical was mixed. Then, 1.0 part by mass of 3-butenoic acid additive of 9,9-bis(4-(2-hydroxyphenyl)fluorene diglycigyl ether as the compound having radical polymerization reactive group, 4.0 parts by mass of phenyl(4-vinylphenyl)sulfide (made by NIPPON STEEL & SUMIKIN CHEMICAL CO., LTD.) as the radical polymerization monomer, 0.6 part by mass of bis(η⁵-2,4-cyclopenthadiene-1-yl)-bis(2,6-difluoro-3-(1H-pyrol-1-yl)-phenyl)titanium (made by BASF Ltd., IRGACURE 784) as the photo-radical polymerization initiator and 4.0 parts by mass of o-acetyl tributyl citrate (made by TOKYO CHEMICAL INDUSTRY CO., LTD, refractive index nD=1.441) as the plasticizer were mixed to blend the intended the photosensitive material.

The photosensitive material was introduced into the space formed by the laminate made of two glass substrate (30 mm×30 mm) which are laminated via silicone film spacer. Then, the laminate was heated for two hours at 60° C. under nitrogen atmosphere so as to form the holographic recording medium having the information recording layer with a thickness of 0.2 mm or 0.3 mm which was made of the photosensitive material between the two substrates of the laminate.

### Example 2

The intended holographic recording medium was obtained in the same manner as Example 1 except that 0.1 part by mass (0.056 molar ratio for the corresponding polymerization monomer) of 4-hydroxy-2,2,6,6-tetramethylpipelidine-1-oxyl, 2.0 parts by mass of phenyl(4-vinylphenyl)sulfide and 6.0 parts by mass of o-acetyl tributyl citrate were mixed.

### Example 3

The intended holographic recording medium was obtained in the same manner as Example 2 except that 58.5 parts by mass of pentaerythritol propoxylate (made by Sigma-Aldrich Co., LLC, mean molecular weight: 629, refractive index nD=1.460) instead of the polyethertriol and 31.7 parts by mass of hexamethylene diisocyanate were mixed.

### Example 4

The intended holographic recording medium was obtained in the same manner as Example 3 except that 0.2 part by mass of (0.112 molar ratio for the corresponding polymerization monomer) of 4-hydroxy-2,2,6,6-tetramethylpipelidine-1-oxyl is mixed.

### Example 5

The intended holographic recording medium was obtained in the same manner as Example 3 except that 32.7 parts by mass of hexamethylene diisocyanate, 60.5 parts by mass of pentaerythritol propoxylate and 3.0 parts by mass of o-acetyl tributyl citrate were mixed.

### Comparative Example 1

A prescribed holographic recording medium was obtained in the same manner as Example 1 except that N-tert-butyl-α-phenylnitrone (which is polymerization inhibitor different from the stable nitroxyl radical) instead of 4-hydroxy-2,2,6,6-tetramethylpipelidine-1-oxyl was mixed.

### Comparative Example 2

A prescribed holographic recording medium was obtained in the same manner as Example 2 except that N-tert-butyl-α-phenylnitrone (which is polymerization inhibitor different from the stable nitroxyl radical) instead of 4-hydroxy-2,2,6,6-tetramethylpipelidine-1-oxyl was mixed.

The composition of each of the photosensitive precursors obtained in Examples 1 to 5 and Comparative Examples 1 to 2 is listed in Table 1.

TABLE 1

| | | | EXAMPLE | EXAMPLE | EXAMPLE | EXAMPLE | EXAMPLE | COMPARATVE | COMPARATIVE |
|---|---|---|---|---|---|---|---|---|---|
| | | | 1 | 2 | 3 | 4 | 5 | EXAMPLE 1 | EXAMPLE 2 |
| POLYMER | POLYOL | POLYETHERTRIOL | 56.3 | 56.3 | — | — | — | 59.1 | 60.4 |
| MATRIX | | (MEAN MOLECULAR WEIGHT 425) | | | | | | | |
| FORMATION | | (PART BY MASS) | | | | | | | |
| COMPONENTS | | PENTAERYTHRITOL PROXYLATE | — | — | 58.5 | 58.5 | 60.5 | — | — |
| | | (MEAN MOLECULAR WEIGHT 629) | | | | | | | |
| | | (PART BY MASS) | | | | | | | |
| | POLYISOCYANATE | HEXAMETHYLENE DIISOCYANATE | 33.8 | 33.8 | 31.7 | 31.7 | 32.7 | 35.4 | 36.1 |
| | COMPOUND HAVING | (PART BY MASS) | | | | | | | |
| | RADICAL | 3-BUTENOIC ACID ADDTIVE OF 9,9-BIS | 1.0 | 1.0 | 1.0 | 1.0 | 1.0 | 1.0 | 1.0 |
| | POLMERIZATION | (4-(2-HYDROXYPHENYL) FLUORENE | | | | | | | |
| | REACTIVE GROUP | DIGLYCIGIL ETHER (PART BY MASS) | | | | | | | |
| | STABLE NITROXYL RADICAL | 4-HYDROXY-2,2,6,6-TETRAMETHYL | 0.2 | 0.1 | 0.1 | 0.2 | 0.1 | — | — |
| | (WITH REACTIVE GROUP) | PIPELIDINE-1-OXYL | | | | | | | |
| | | (PART BY MASS) | | | | | | | |
| | | 4-AMINO-2,2,6,6-THTRAMETHYL | — | — | — | — | — | — | — |
| | | PIPELIDINE-1-OXYL (PART BY MASS) | | | | | | | |

| | | | | | | | | |
|---|---|---|---|---|---|---|---|---|
| STABLE NITROXYL RADICAL | 4-METHOXY-2,2,6,6-THTRAMETHYL | — | — | — | — | — | — | — |
| (WITHOUT REACTIVE GROUP) | PIPELIDINE-1- OXYL (PART BY MASS) | | | | | | | |
| | 4-OXO-2,2,6,6,-TETRAMETHYLPIPELIDINE- | — | — | — | — | — | — | — |
| | 1-OXYL (PART BY MASS) | | | | | | | |
| | 2,2,6,6-TETRAMETHYLPIPELIDINE- | — | — | — | — | — | — | — |
| | 1-OXYL (PART BY MASS) | | | | | | | |
| POLYMERIZATION INHIBITOR | N-tert-BUTYL-α-PHENYL-NITRONE | — | — | — | — | — | 0.20 | 0.10 |
| | (PART BY MASS) | | | | | | | |
| POLYMER MATRIX FORMATION CATALYST | DIBUTHYLTIN DILAURATE (PART BY MASS) | 0.08 | 0.08 | 0.06 | 0.06 | 0.06 | 0.08 | 0.08 |
| RADICAL POLYMERIZATION MONOMER | PHENYL(4-VINYLPHENYL)SULFIDE | 4.0 | 2.0 | 2.0 | 2.0 | 2.0 | 4.0 | 2.0 |
| | (PART BY MASS) | | | | | | | |
| PHOTO-RADICAL POLYMERIZATION | IRGACURE784 (PART BY MASS) | 0.6 | 0.6 | 0.6 | 0.6 | 0.6 | 0.3 | 0.3 |
| INITIATOR | | | | | | | | |
| PLASTICIZER | O-ACETYL TRIBUTYL CITRATE | 4.0 | 6.0 | 6.0 | 6.0 | 3.0 | — | — |

| | | | | | | | |
|---|---|---|---|---|---|---|---|
| MOLAR RATIO OF STABLE NITROXYL RADICAL TO RADICAL POLYMERIZATION MONOMER | 0.056 | 0.056 | 0.056 | 0.112 | 0.056 | — | — |
| MOLAR RATIO OF POLYMERIZATION INHBITOR TO RADICAL POLYMERIZATION MONOMER | — | — | — | — | — | 0.055 | 0.055 |

### Examples 6 to 9 and Comparative Examples 3 to 8

The intended holographic recording medium was obtained in the same manner as Example 1 except the photosensitive materials were blended respectively as listed in Table 2.

TABLE 2

| | | | | | COMPARATVE | COMPARATIVE | COMPARATIVE |
|---|---|---|---|---|---|---|---|
| | | | EXAMPLE 6 | EXAMPLE 7 | EXAMPLE 3 | EXAMPLE 4 | EXAMPLE 5 |
| POLYMER | POLYOL | POLYETHERTRIOL | 58.7 | 58.7 | 58.8 | 58.8 | 58.8 |
| MATRIX | | (MEAN MOLECULAR WEIGHT 425) (PART BY MASS) | | | | | |
| FORMATION | | PENTAERYTHRITOL PROXYLATE | — | — | — | — | — |
| COMPONENTS | | (MEAN MOLECULAR WEIGHT 629) (PART BY MASS) | | | | | |
| | POLYISOCYANATE | HEXAMETHYLENE DIISOCYANATE (PART BY MASS) | 35.3 | 35.3 | 35.2 | 35.2 | 35.2 |
| | COMPOUND HAVING RADICAL | 3-BUTENOIC ACID ADDTIVE OF 9,9-BIS | 1.0 | 1.0 | 1.0 | 1.0 | 1.0 |
| | POLMERIZATION REACTIVE GROUP | (4-(2-HYDROXYPHENYL) FLUORENE | | | | | |
| | | DIGLYCIGIL ETHER (PART BY MASS) | | | | | |
| | STABLE NITROXYL RADICAL | 4-HYDROXY-2,2,6,6-TETRAMETHYL PIPELIDINE-1- | 0.3 | — | — | — | — |
| | (WITH REACTIVE GROUP) | OXYL (PART BY MASS) | | | | | |
| | | 4-AMINO-2,2,6,6-THTRAMETHYL PIPELIDINE-1- | — | 0.3 | — | — | — |
| | | OXYL (PART BY MASS) | | | | | |

| | | | | | | |
|---|---|---|---|---|---|---|
| STABLE NITROXYL RADICAL | 4-METHOXY-2,2,6,6-THTRAMETHYL PIPELIDINE-1- | — | — | 0.3 | — | — |
| (WITHOUT REACTIVE GROUP) | OXYL (PART BY MASS) | | | | | |
| | 4-OXO-2,2,6,6,-TETRAMETHYLPIPELIDINE-1-OXYL | — | — | — | 0.3 | — |
| | (PART BY MASS) | | | | | |
| | 2,2,6,6-TETRAMETHYLPIPELIDINE-1-OXYL | — | — | — | — | 0.3 |
| | (PART BY MASS) | | | | | |
| POLYMERIZATION INHIBITOR | N-tert-BUTYL-α-PHENYL-NITRONE | — | — | — | — | — |
| | (PART BY MASS) | | | | | |
| POLYMER MATRIX FORMATION CATALYST | DIBUTHYLTIN DILAURATE (PART BY MASS) | 0.08 | 0.08 | 0.08 | 0.08 | 0.08 |
| RADICAL POLYMERIZATION MONOMER | PHENYL(4-VINYLPHENYL)SULFIDE | 4.0 | 4.0 | 4.0 | 4.0 | 4.0 |
| | (PART BY MASS) | | | | | |
| PHOTO-RADICAL POLYMERIZATION INITIATOR | IRGACURE784 (PART BY MASS) | 0.6 | 0.6 | 0.6 | 0.6 | 0.6 |
| PLASTICIZER | O-ACETYL TRIBUTYL CITRATE | — | — | — | — | — |

| | | | | | |
|---|---|---|---|---|---|
| MOLAR RATIO OF STABLE NITROXYL RADICAL TO RADICAL POLYMERIZATION MONOMER | 0.084 | 0.085 | 0.078 | 0.085 | 0.093 |
| MOLAR RATIO OF POLYMERIZATION INHBITOR TO RADICAL POLYMERIZATION MONOMER | — | — | — | — | — |

| | | | COMPARATIVE | COMPARATIVE | | | COMPARATIVE |
|---|---|---|---|---|---|---|---|
| | | | EXAMPLE 6 | EXAMPLE 7 | EXAMPLE 8 | EXAMPLE 9 | EXAMPLE 8 |
| POLYMER | POLYOL | POLYETHERTRIOL | 56.5 | 56.4 | 56.3 | 56.2 | 56.0 |
| MATRIX | | (MEAN MOLECULAR WEIGHT 425) (PART BY MASS) | | | | | |
| FORMATION | | PENTAERYTHRITOL PROXYLATE | — | — | — | — | — |
| COMPONENTS | | (MEAN MOLECULAR WEIGHT 629) (PART BY MASS) | | | | | |
| | POLYISOCYANATE | HEXAMETHYLENE DIISOCYANATE (PART BY MASS) | 33.8 | 33.8 | 33.8 | 33.8 | 33.8 |
| | COMPOUND HAVING RADICAL | 3-BUTENOIC ACID ADDTIVE OF 9,9-BIS | 1.0 | 1.0 | 1.0 | 1.0 | 1.0 |
| | POLMERIZATION REACTIVE GROUP | (4-(2-HYDROXYPHENYL) FLUORENE | | | | | |
| | | DIGLYCIGIL ETHER (PART BY MASS) | | | | | |
| | STABLE NITROXYL RADICAL | 4-HYDROXY-2,2,6,6-TETRAMETHYL PIPELIDINE-1- | — | 0.05 | 0.2 | 0.3 | 0.5 |
| | (WITH REACTIVE GROUP) | OXYL (PART BY MASS) | | | | | |
| | | 4-AMINO-2,2,6,6-THTRAMETHYL PIPELIDINE-1- | — | — | — | — | — |
| | | OXYL (PART BY MASS) | | | | | |

| | | | | | | |
|---|---|---|---|---|---|---|
| STABLE NITROXYL RADICAL | 4-METHOXY-2,2,6,6-THTRAMETHYL PIPELIDINE-1- | — | — | — | — | — |
| (WITHOUT REACTIVE GROUP) | OXYL (PART BY MASS) | | | | | |
| | 4-OXO-2,2,6,6,-TETRAMETHYLPIPELIDINE-1-OXYL | — | — | — | — | — |
| | (PART BY MASS) | | | | | |
| | 2,2,6,6-TETRAMETHYLPIPELIDINE-1-OXYL | — | — | — | — | — |
| | (PART BY MASS) | | | | | |
| POLYMERIZATION INHIBITOR | N-tert-BUTYL-α-PHENYL-NITRONE | — | — | — | — | — |
| | (PART BY MASS) | | | | | |
| POLYMER MATRIX FORMATION CATALYST | DIBUTHYLTIN DILAURATE (PART BY MASS) | 0.08 | 0.08 | 0.08 | 0.07 | 0.07 |
| RADICAL POLYMERIZATION MONOMER | PHENYL(4-VINYLPHENYL)SULFIDE | 2.0 | 2.0 | 2.0 | 2.0 | 2.0 |
| | (PART BY MASS) | | | | | |
| PHOTO-RADICAL POLYMERIZATION INITIATOR | IRGACURE784 (PART BY MASS) | 0.6 | 0.6 | 0.6 | 0.6 | 0.6 |
| PLASTICIZER | O-ACETYL TRIBUTYL CITRATE | 6.0 | 6.0 | 6.0 | 6.0 | 6.0 |

| | | | | | |
|---|---|---|---|---|---|
| MOLAR RATIO OF STABLE NITROXYL RADICAL TO RADICAL POLYMERIZATION MONOMER | — | 0.028 | 0.112 | 0.168 | 0.280 |
| MOLAR RATIO OF POLYMERIZATION INHBITOR TO RADICAL POLYMERIZATION MONOMER | — | — | — | — | — |

<Evaluation of Holographic Recording/Reproducing>

The evaluation of holographic recording/reproducing was conducted by using a holographic recording/reproducing evaluation device on two beam interference method. The multiple recording was conducted as the combination of angle multiplication and peristrophic multiplication.

(Plane Wave Recording/Reproducing Method)

The evaluation of M# and recording sensitivity was conducted by using the plane wave tester (SHOT-500G, made by Pulstec Industrial Co., LTD). The recording and reproducing were conducted using a continuous wave oscillation all solid laser of a wavelength of 532 nm.

[Recording Condition of Plane Wave]

Exposure before recording: None

Recording scheduling: None

Multiplication: 49

Angle direction: 7 (−6 to +6° by 2° step)
Peristrophic: 7 (−60 to +60° by 20° step)
Total exposure amount: 5000 mJ/cm²
Exposure after recording: 10000 mJ/cm² by LED

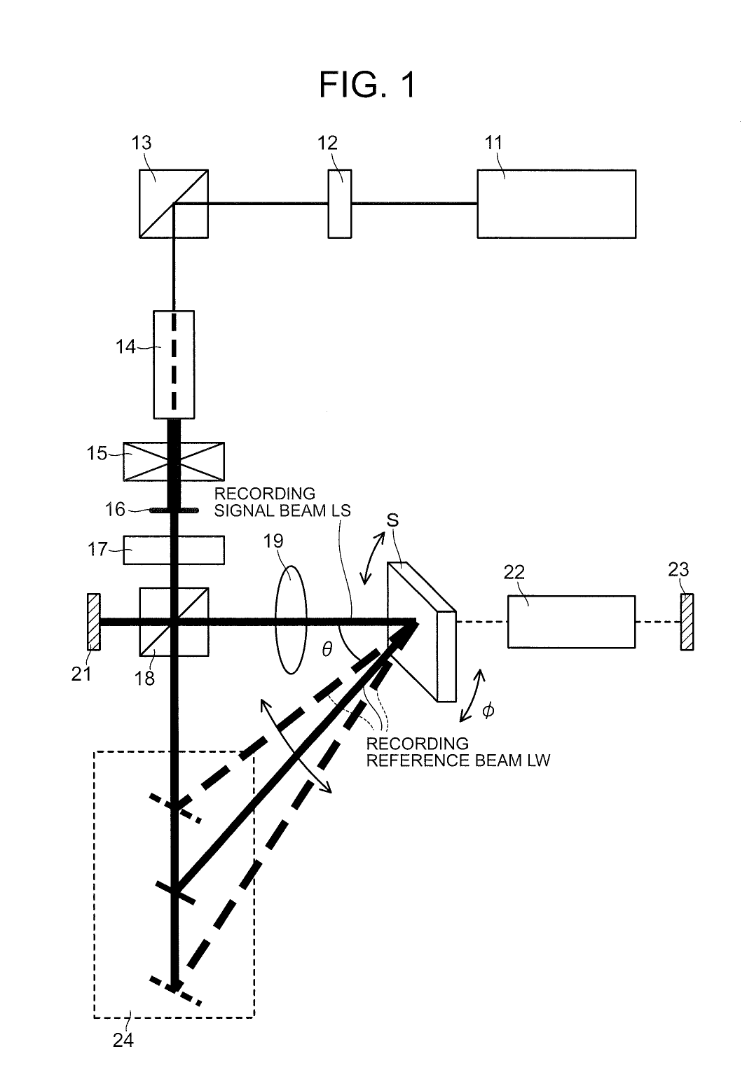

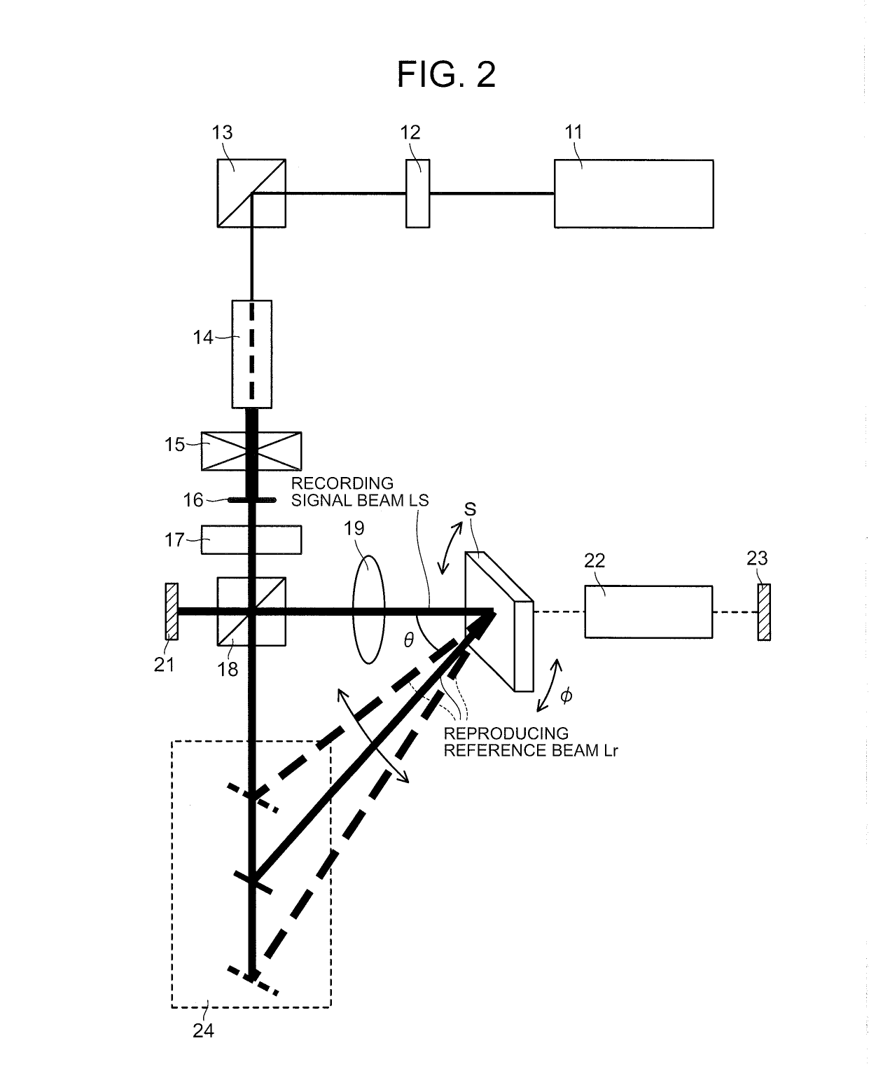

The evaluation of SNR was conducted by the recording/reproducing of page data using the optical systems shown in FIGS. 1 and 2.

(Recording Method of Page Data)

First of all, the recording method of page data will be described using the optical system shown in FIG. 1.

The laser beam emitted from the laser (YAG laser of a wavelength of 532 nm) 11 is propagated along the optical path, controlled in power at the half wavelength plate (HWP) 12 and reflected downward at the polarization beam splitter (PBS) 13. Then, the laser beam is expanded in beam diameter at the beam expander 14, narrowed in beam diameter at the aperture stop 16 through the shutter 15 and arrives at the polarization beam splitter (PBS) 18 through the half wavelength plate 17. At the PBS 18, the laser beam is divided into two laser beams, and the one laser beam is reflected at the spatial light modulator (SLM) 21, focused as the recording signal beam Ls and irradiated onto the holographic recording medium S.

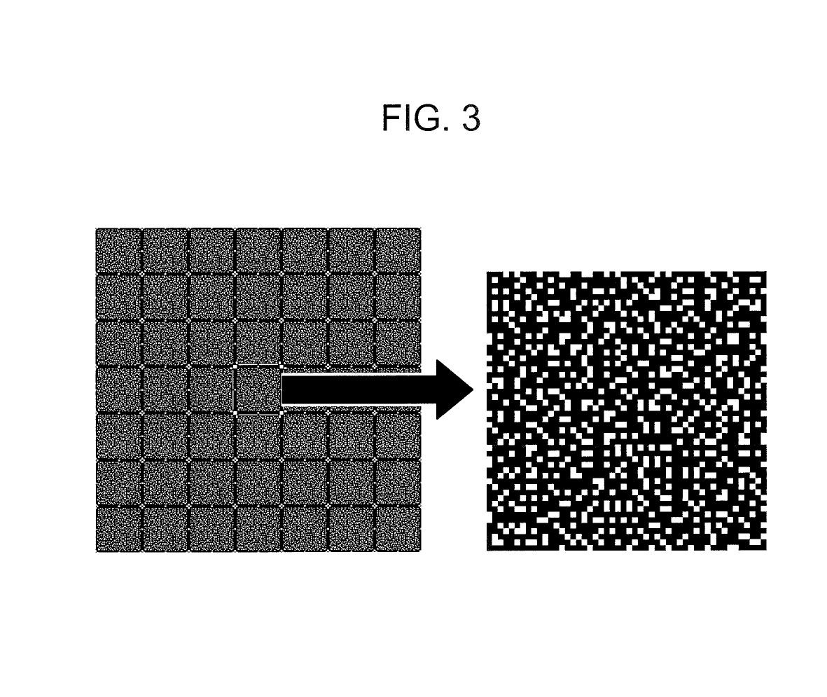

The HWP 12 functions as controlling the whole of the optical system in power and the HWP 17 functions as controlling the power ratio of the signal beam to reference beam. Moreover, the SLM 21 modulates the laser beam to form the recording signal beam which is formed as low and high-brightness dot pattern. For example, the dot pattern as shown in FIG. 3 is formed as the recording signal beam. The left side of FIG. 3 depicts the arrangement of 7×7 dot pattern matrix, each dot pattern being made of 50×50 dots, which constitutes 122.5 k bits. The right side of FIG. 3 depicts an enlarged view of one dot pattern.

The other laser beam divided at the PBS 18 is introduced into the angles canning mechanism 24 and thus scanned at a prescribed angle, and irradiated as the recording reference beam Lw onto the holographic recording medium S at the angle of θ.

In this case, the first page signal is displayed at the SLM 21 and recorded at the holographic recording medium while the shutter is opened for the exposure thereto for a prescribed period of time under the condition that the angles θ and φ are set to respective prescribed values. Then, the second page signal is recorded at the holographic recording medium while the shutter is opened for the exposure thereto for a prescribed period of time under the condition that the angles θ and φ are set to respective prescribed values. Then, the aforementioned process was repeated until the intended multiple recording was conducted.

[Condition of Page Date Recording]

Exposure before recording: None

Recording scheduling: None

Multiplication: 540 or 135

Angle direction: 15 (θ=50 to 64° by 1°)

Peristrophic: 36 (φ=0 to 350° by 10° step) or 9 (φ=0 to 320° by 40° step)

Total exposure amount: 1500 to 2700 mJ/cm²

Exposure after recording: 54000 mJ/cm² or more by LED

The exposure after recording is intended for the stabilization of the holographic recording medium through the polymerization of the remnant monomer therein.

(Reproducing Method of Page Data)

Then, the reproducing method of page data will be described using the optical system shown in FIG. 2.

The imaging optical system 22 and the imager 23 such as a CMOS or CCD are disposed at the rear side of the holographic recording medium S. The imaging optical system 22 is composed of a plurality of lenses and disposed such that the recorded dot patterns are imaged on the imager 23.

In reproducing, the laser beam emitted from the laser 11 arrives at the angle scanning mechanism 24 through the HWP 12, the PBS 13 and the beam expander 14 under the condition that the shutter 15 is opened, and is irradiated as the reproducing reference beam Lr onto the holographic recording medium S. In this case, the angles θ and φ are set to respective prescribed values corresponding to a predetermined pages (pages to be desired in reproducing) and the reproducing reference beam Lr is irradiated onto the holographic recording medium S so as to take the diffraction beam as the reproducing signal beam out of the holographic recording medium S. The diffraction beam is introduced into imager 23 through the imaging optical system 22 and thus obtained as the corresponding reproduced image which is 2/4-demodulated dependent on brightness so as to obtain the corresponding reproducing signal. The SNR was calculated in the same manner as T. Ando, et al: Jpn. J. Appl. Phys. 46, 6B (2007) 3855.

<Evaluation Result>

[Plane Wave Recording Characteristic]

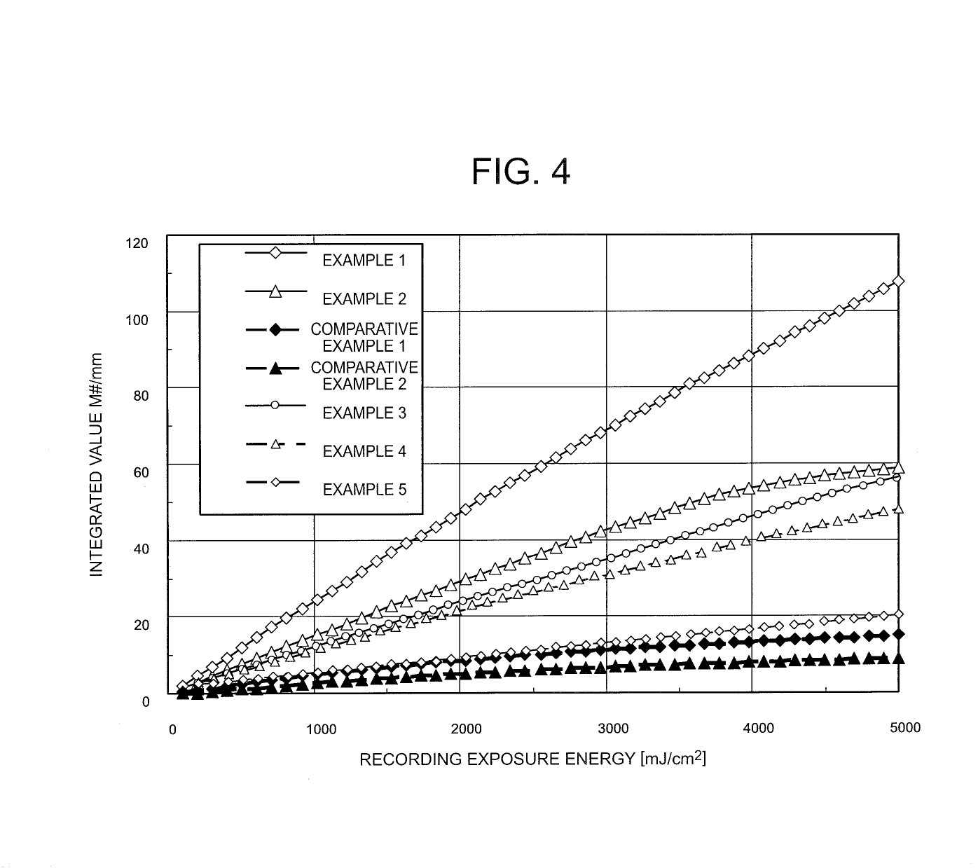

FIG. 4 is an integrated value of M# for recording exposure energy. The holographic recording medium obtained in each of Examples 1 to 5 has a higher M# in comparison to the holographic recording medium obtained in each of Comparative Examples 1 to 2 and thus are excellent in multiple recording.

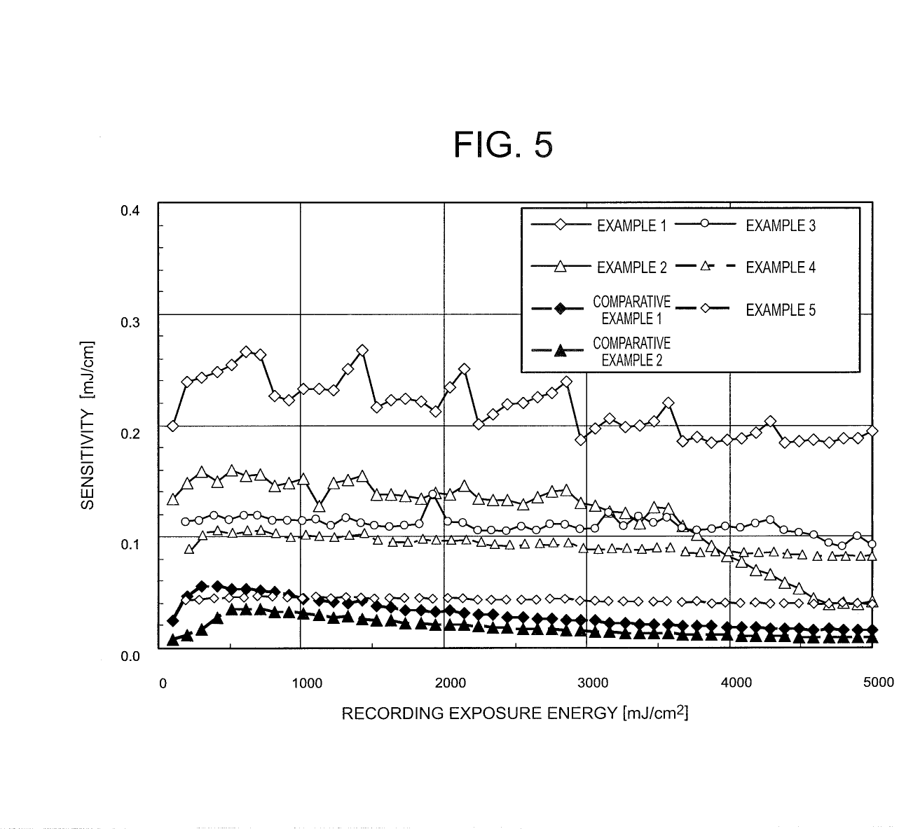

FIG. 5 is a recording sensitivity for recording exposure energy. The holographic recording medium obtained in each of Examples 1 to 5 has a higher recording sensitivity in comparison to the holographic recording medium obtained in each of Comparative Example 1 to 2 and thus can realize higher data transfer rate. Moreover, the holographic recording medium obtained in each of Comparative Examples 1 to 2 has a larger variation in sensitivity while the holographic recording medium obtained in each of Examples 1 to 5 has a higher uniformity in sensitivity in the range of 3500 mJ/cm² or less and thus does not require scheduling. Furthermore, the holographic recording medium has a sufficient sensitivity from first page recording in comparison to the holographic recording medium obtained in each of Comparative Examples 1 to 2 and thus does not require exposure before recording.

The M#, the average sensitivity from first page recording to 35-th page recording (recording exposure energy=3571.4 mJ/cm2) and the uniformity of sensitivity (Smin/Smax) from first page recording to 35-th page recording are listed in Tables 3, 4.

TABLE 3

| | EXAMPLE | EXAMPLE | EXAMPLE | EXAMPLE | | COMPARATIVE | COMPARATIVE |
|---|---|---|---|---|---|---|---|
| | 1 | 2 | 3 | 4 | EXAMPLE 5 | EXAMPLE 1 | EXAMPLE 2 |
| MULTIPLICATION M#(/mm) | 80.7 | 49.6 | 41.0 | 35.8 | 14.5 | 12.5 | 7.6 |
| FROM FIRST PAGE RECORDING | | | | | | | |
| TO 35-TH PAGE RECORDING | | | | | | | |
| AVERAGE SENSITIVITY (cm/mJ) | 0.226 | 0.146 | 0.115 | 0.100 | 0.041 | 0.033 | 0.018 |
| FROM FIRST PAGE RECORDING | | | | | | | |
| TO 35-TH PAGE RECORDING | | | | | | | |
| Smin/Smax | 0.70 | 0.71 | 0.76 | 0.81 | 0.91 | 0.37 | 0.35 |
| FROM FIRST PAGE RECORDING | | | | | | | |
| TO 35-TH PAGE RECORDING | | | | | | | |

TABLE 4

| | | | COMPARATIVE | COMPARATIVE | COMPARATIVE |
|---|---|---|---|---|---|
| | EXAMPLE 6 | EXAMPLE 7 | EXAMPLE 3 | EXAMPLE 4 | EXAMPLE 5 |
| MULTIPLICATION M#(/mm) FROM FIRST | 27 | 2.9 | 0.3 | 0.4 | 0.4 |
| PAGE RECORDING TO 35-TH PAGE | | | | | |
| RECORDING | | | | | |
| AVERAGE SENSITIVITY (cm/mJ) FROM | 0.008 | 0.008 | 0.001 | 0.001 | 0.001 |
| FIRST PAGE RECORDING TO 35-TH PAGE | | | | | |
| RECORDING | | | | | |
| Smin/Smax FROM FIRST PAGE | 0.86 | 0.89 | 0.50 | 0.58 | 0.61 |
| RECORDING TO 35-TH PAGE RECORDING | | | | | |

| | COMPARATIVE | COMPARATIVE | | | COMPARATIVE |
|---|---|---|---|---|---|
| | EXAMPLE 6 | EXAMPLE 7 | EXAMPLE 8 | EXAMPLE 9 | EXAMPLE 8 |
| MULTIPLICATION M#(/mm) FROM FIRST | 7.4 | 29.4 | 33.2 | 52.3 | 2.4 |
| PAGE RECORDING TO 35-TH PAGE | | | | | |
| RECORDING | | | | | |
| AVERAGE SENSITIVITY (cm/mJ) FROM | 0.021 | 0.082 | 0.093 | 0.147 | 0.007 |
| FIRST PAGE RECORDING TO 35-TH PAGE | | | | | |
| RECORDING | | | | | |
| Smin/Smax FROM FIRST PAGE | 0.01 | 0.03 | 0.58 | 0.71 | 0.71 |
| RECORDING TO 35-TH PAGE RECORDING | | | | | |

Since the radical polymerization monomer functions as forming the refractive index modulation structure in holographic recording, the M# and the sensitivity of the holographic recording medium can be developed as the content of the radical polymerization monomer is increased, but in view of polymerization shrinkage, it is desired that a higher M# and sensitivity can be obtained by a smaller content of the radical polymerization monomer.

As is apparent from Tables 1 and 3, in comparison of the holographic recording medium to the one having the same radical polymerization monomer, the holographic recording medium obtained in each of Examples has a higher M# and sensitivity than the one obtained in each of Comparative Examples.

Moreover, the ratio (Smin/Smax) of the holographic recording medium obtained in each of Examples 1 to 5 are 0.7 or more and thus these holographic recording media do not require scheduling, but the ratio (Smin/Smax) of the holographic recording medium obtained in each of Comparative Examples 1 to 2 are less than 0.5 and thus these holographic recording media require scheduling

As is apparent from Tables 2 and 4, even though the stable nitroxyl radical has no reactive group capable of being coupled with the side chains of the polymer matrix (Comparative Examples 3 to 5), the integral M# and the average sensitivity of the holographic recording medium are conspicuously deteriorated.

As is apparent from Tables 2 and 4, moreover, in the case that the stable nitroxyl radical is not contained in the holographic recording medium (Comparative Example 6), the integral M# and the average sensitivity of the holographic recording medium are low and the uniformity of sensitivity (Smin/Smax) thereof is conspicuously low.

As is apparent from Tables 2 and 4, furthermore, in the case that the stable nitroxyl radical is little contained in the holographic recording medium (Comparative Example 7), the uniformity of sensitivity (Smin/Smax) of the holographic recording medium is conspicuously low and in contrast, in the case that the stable nitroxyl radical is largely contained in the holographic recording medium, the integral M# and the average sensitivity of the holographic recording medium.

[Recording Characteristic of Page Data]

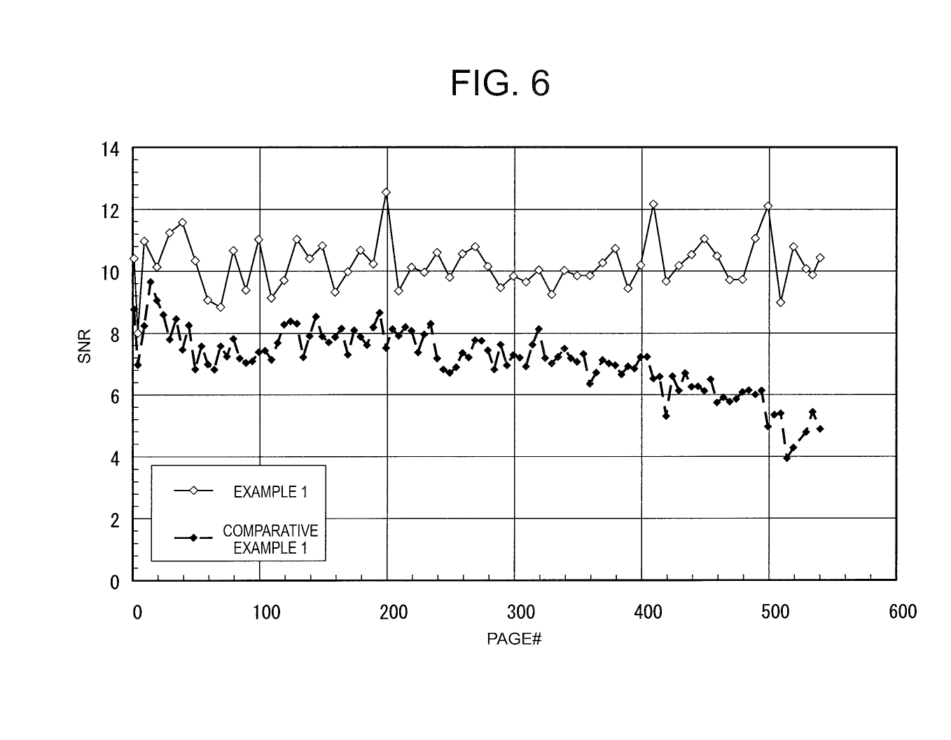

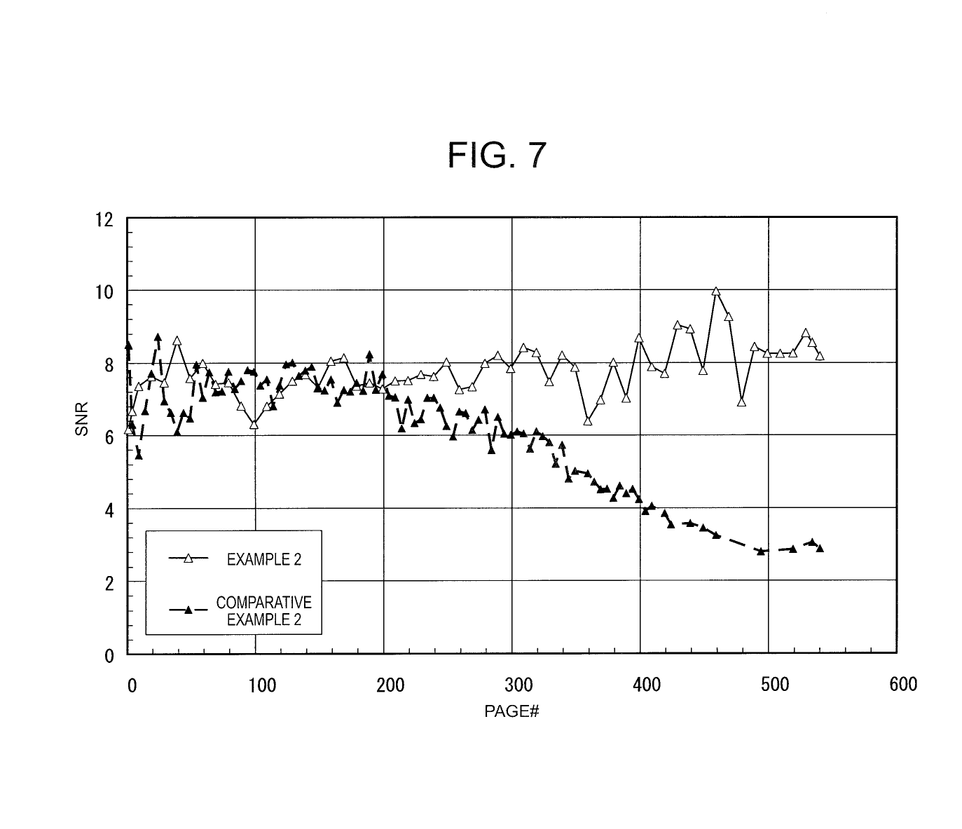

FIGS. 6 and 7 are graphs showing SNR per page in the 540 multiple recording. FIG. 6 relates to graphs where the content of the radical polymerization monomer is set to 4.0 parts by mass and FIG. 7 relates to graphs where the content of the radical polymerization monomer is set to 2.0 parts by mass. The scheduling is not conducted for the holographic recording medium obtained in each of Examples and the scheduling is conducted for the holographic recording medium obtained in each of Comparative Examples. In FIGS. 6 and 7, the holographic recording medium obtained in Example has a higher SNR than the one obtained in Comparative Example. The holographic recording medium in each of Examples has higher SNRs over the whole of the pages without the scheduling because it has a higher uniformity of sensitivity while the holographic recording medium in each of Comparative Example has lower SNRs at the latter pages with the scheduling because it has a lower uniformity of sensitivity at the latter pages.

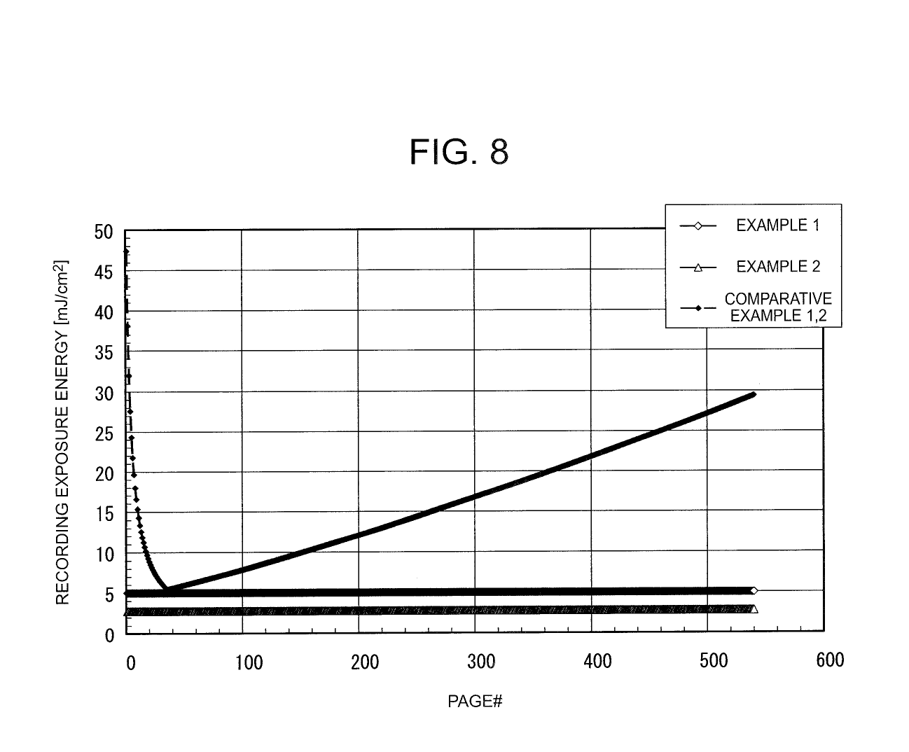

FIG. 8 is a graph showing the scheduling, that is, the recording exposure energy in the 540 multiple recording. Since the holographic recording medium obtained in each of Examples has a higher sensitivity and uniformity of sensitivity, it can have a higher SNR and can realize a higher data transfer rate by lower constant recording exposure energy. On the other hand, since the holographic recording medium obtained in each of Comparative Example requires the scheduling, the recording exposure energy is increased as the number of recording is increased (multiple recording proceeds).

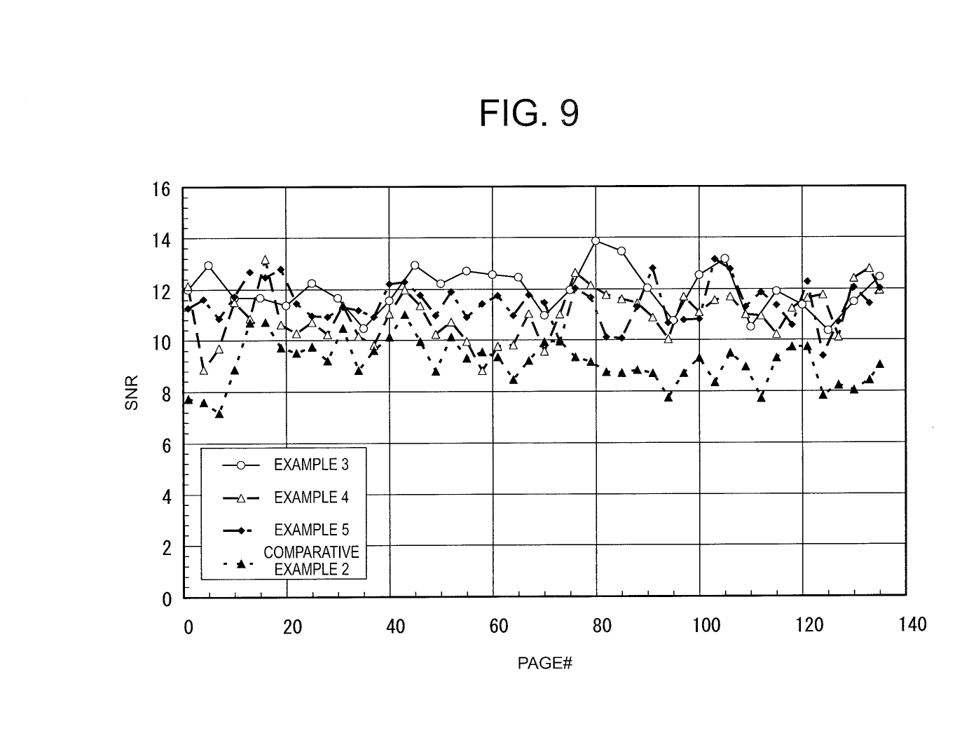

FIG. 9 is graphs showing SNRs of the holographic recording media obtained in Examples 3 to 5 and Comparative Example 2 in the 135 multiple recording without the scheduling. Even though the number of recording is small, the SNRs of the holographic recording media obtained in Examples are higher than the one obtained in Comparative Example.

The average SNR, the total exposure energy and scheduling/non-scheduling of each of the holographic recording media in the 540 multiple recording and 135 multiple recording are listed in Tables 5 and 6.

TABLE 5

| | | RECODING | |
|---|---|---|---|
| | AVERAGE SNR | TOTAL | |
| | (540 | ENERGY | |
| | MULTIPLICATION) | (mJ/cm²) | SCHEDULING |
| EXAMPLE 1 | 10.23 | 2700 | NO |
| EXAMPLE 2 | 7.76 | 1500 | NO |
| EXAMPLE 1 | 7.10 | 8870 | YES |
| EXAMPLE 2 | 5.71 | 8870 | YES |

TABLE 6

| | | RECODING | |
|---|---|---|---|
| | AVERAGE SNR | TOTAL | |
| | (540 | ENERGY | |
| | MULTIPLICATION) | (mJ/cm²) | SCHEDULING |
| EXAMPLE 1 | 11.58 | 2700 | NO |
| EXAMPLE 3 | 11.97 | 2000 | NO |
| EXAMPLE 4 | 10.95 | 5000 | NO |
| EXAMPLE 5 | 11.44 | 5000 | NO |
| COMPARATIVE | 9.19 | 5000 | NO |
| EXAMPLE 1 | | | |
| COMPARATIVE | 9.14 | 5000 | NO |
| EXAMPLE 1 | | | |

Although the present invention was described in detail with reference to the above examples, this invention is not limited to the above disclosure and every kind of variation and modification may be made without departing from the scope of the present invention.

What is claimed is:

1. A photosensitive material, comprising:
a polymer matrix, a radical polymerization monomer and photo-radical polymerization initiator,
wherein the polymer matrix has stable nitroxy radical at side chain thereof,
wherein a molar ratio of the stable nitroxy radical to the radical polymerization monomer is set within a range of 0.03 to 0.25.

2. The photosensitive material as set forth in claim 1,
wherein the stable nitroxy radical is represented by the following chemical formula: 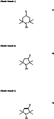
(Z represents hydroxyl group, amino group, carboxyl group, carbamoyl group or glycidyl group).

3. The photosensitive material as set forth in claim 1,
wherein the polymer matrix has aromatic ring and radical polymerization reactive group.

4. The photosensitive material as set forth in claim 3,
wherein contents of the aromatic ring and the radical polymerization reactive group is set within a range of 5 to 20 mass %.

5. The photosensitive material as set forth in claim 3, wherein the aromatic ring and the radical polymerization reactive group are reactive groups, respectively, derived from the following chemical formula: 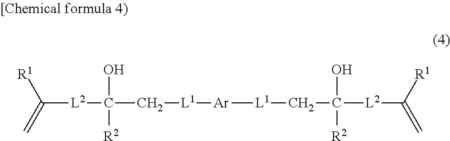
(Ar represents bivalent group having one or more aromatic rings; R¹, R² represent hydrogen atom or methyl group independently; L¹ represents oxygen atom, sulfur atom, —(OR³)nO— (R³ represents alkylene group having 1 to 4 carbon; n=integral number within a range of 1 to 4); L² represents bivalent group capable of having aromatic ring).

6. The photosensitive material as set forth in claim 3,
wherein the aromatic ring and the radical polymerization reactive group are reactive groups, respectively, derived from the following chemical formula: 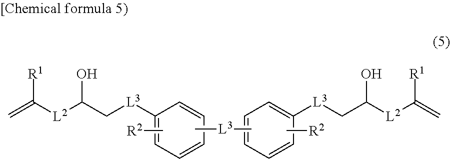
(R¹ represents hydrogen atom or methyl group; R² represents hydrogen atom or alkyl group having 1 to 4 carbon; L¹ represents oxygen atom, sulfur atom, —(OR³)nO— (R³ represents alkylene group having 1 to 4 carbon; n=integral number within a range of 1 to 4); L² represents bivalent group capable of having aromatic ring; L³ represents single bond, oxygen atom, sulfur atom, sulfonyl atom, alkylene group having 1 to 4 carbon or 9,9-fluorenyl group).

7. The photosensitive material as set forth in claim 3,
wherein the aromatic ring and the radical polymerization reactive group are reactive groups, respectively, derived from the following chemical formula: 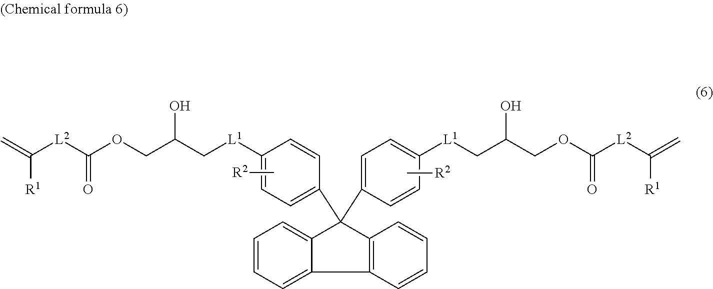
(R¹ represents hydrogen atom or methyl group; R² represents hydrogen atom or alkyl group having 1 to 4 carbon; L¹ represents oxygen atom, sulfur atom, —(OR³)nO— (R³ represents alkylene group having 1 to 4 carbon; n=integral number within a range of 1 to 4); L² represents bivalent group capable of having aromatic ring; L⁴ represents single bond or methylene group).

8. A holographic recording medium, comprising:
at least one transparent substrate; and
an information recording layer made of a photosensitive material as set forth in claim 1 and formed on the transparent substrate.

9. A holographic recording medium, comprising:
at least one transparent substrate; and
an information recording layer made of a photosensitive material as set forth in claim 3 and formed on the transparent substrate.

10. A holographic recording method, comprising a step of:
forming a plurality of refractive index modulation diffraction gratings which are superimposed in a holographic recording medium as set forth in claim 8 by the same exposure energy.

11. A holographic recording method, comprising a step of:
forming a plurality of refractive index modulation diffraction gratings which are superimposed in a holographic recording medium as set forth in claim 9 by the same exposure energy.

12. A holographic recording method, comprising a step of:
forming at least one refractive index modulation diffraction grating in a holographic recording medium as set forth in claim 8 without preliminary exposure.

13. A holographic recording method, comprising a step of:
forming at least one refractive index modulation diffraction grating in a holographic recording medium as set forth in claim 9 without preliminary exposure.
